(19) United States
(12) Patent Application Publication
(10) Pub. No.: US 2025/0087809 A1
(43) Pub. Date: Mar. 13, 2025

(54) Absorber Structure, Energy Storage Arrangement, High-Voltage Store, and Process for Manufacturing an Absorber Structure

(71) Applicant: Bayerische Motoren Werke Aktiengesellschaft, Muenchen (DE)

(72) Inventors: Savo ASANIN, Muenchen (DE); Julian PATSCHEIDER, Muenchen (DE); Peter ROESCH, Muenchen (DE); Florian SOLDNER, Brannenburg (DE); Paul WINKLER, Muenchen (DE)

(21) Appl. No.: 18/294,333

(22) PCT Filed: Jul. 12, 2022
(86) PCT No.: PCT/EP2022/069460

§ 371 Date: Feb. 1, 2024

(30) Foreign Application Priority Data
Aug. 4, 2021 (DE) 10 2021 120 233.7

(51) Int. Cl. H01M 50/242; H01M 50/213; H01M 50/229; H01M 50/231; H01M 50/249

(52) U.S. Cl. CPC H01M 50/242; H01M 50/213; H01M 50/229; H01M 50/231; H01M 50/249

(57) ABSTRACT

An absorber structure for high-voltage stores includes a main part made of a first material, the main part having a placement area for placing a multiplicity of energy storage cells thereon. The first material is provided with an additive or, at least in some areas, with a coating. The additive or coating increases the heat resistance of the main part.

### BACKGROUND AND SUMMARY

The present invention relates to an absorber structure for high-voltage stores, to an energy storage arrangement, to an energy store housing and to a method for producing an absorber structure for high-voltage stores.

Nowadays, motor vehicles that are powered partially electrically and fully electrically have very large energy store housings, in which the energy storage cells/batteries are accommodated. In passenger cars, such store housings often occupy a large region of the underbody. For safety reasons, the energy storage cells have to be protected, in particular from below, against mechanical actions. In this context, DE 10 2019 132 026 A1 discloses a battery carrier for a battery of a motor vehicle, comprising a trough-like receiving space for the battery, said receiving space being delimited by a lateral frame and a base, wherein, in the intended installation position of the battery carrier in the motor vehicle, a base outer side of the base points downward and a base inner side of the base points upward, and wherein at least one reinforcing plate having a plurality of material cutouts is arranged on the base inner side and is connected to the base inner side in a shear-resistant manner. The use of such reinforcing plates is not unproblematic, since the weight of the overall arrangement is increased. In addition, it is necessary to ensure that in an energy storage cell a targeted pressure reduction or a degassing is also possible through such a reinforcing plate in the event of a defect.

It is therefore an object of the present invention to provide an absorber structure, an energy storage arrangement, an energy store housing and a method for producing an absorber structure which optimize the known approaches, wherein in particular the aforementioned disadvantages are eliminated.

This object is achieved by means of an absorber structure, by means of an energy storage arrangement, by means of an energy store housing, and by means of a method in accordance with the independent claims. Further advantages and features will emerge from the dependent claims and from the description and the attached figures.

According to the invention, an absorber structure for arrangement of energy storage cells comprises a main body composed of a plastic, wherein the main body comprises an arrangement surface for arrangement of a multiplicity of energy storage cells, and wherein the plastic has an additive and/or the main body has an, in particular fireproof, coating at least in certain regions, said additive or coating increasing the heat/temperature resistance of the main body. In the context of thermal events in energy stores, such as high-voltage stores of motor vehicles, high temperatures and ejection of particles (comprising for example copper and soot particles) may occur during the “venting”. Increasing the heat/temperature resistance of the main body makes it possible to reliably ensure that the absorber structure or the main body as such remains unchanged. Adjoining cells can advantageously be protected against particles when a cell fails. The overall assembly as such also remains unchanged. The cells thus also remain clearly supported in the case of a thermal event. The use of a plastic, which in the present case is also understood to include composite materials that may possibly comprise metallic constituents, makes it possible to construct absorber structures which have very good crash behavior while simultaneously having very low weights.

According to a preferred embodiment, the plastic is a porous material or a foam. According to a preferred embodiment, the foam is an expanded polypropylene (EPP) or polyisocyanurate. The use of foam or a main body which is in the form of a foam body notably makes it possible to construct absorber structures which have very good crash behavior while simultaneously having very low weights.

According to one embodiment, the main body or foam body has a thickness of for example 5-45 mm, particularly preferably a thickness of approximately 10-30 mm. The main body has an upper side and a lower side, wherein the arrangement surface is expediently formed on the upper side. The main body and the arrangement surface extend in one plane, the plane preferably extending parallel to a roadway plane in the intended installation position of the absorber structure. However, this is not absolutely necessary, particularly if for example an absorber structure, used in an energy store housing, is concerned which is used in a motorcycle.

The arrangement surface is the region on which the energy storage cells are indirectly or directly arranged.

According to one embodiment, at least the arrangement surface has a coating. The arrangement surface is formed, as it were, by the coating. According to one embodiment, the arrangement surface or that region of the main body which forms the arrangement surface is of planar/flat and closed form.

According to one embodiment, the coating is applied by means of spraying. The coating may also be referred to as a spray coating. This is readily implementable in terms of process technology. Moreover, other points or regions of the main body may also be provided with a coating if required, in particular for example a lower side of the main body, said lower side also having a coating which increases the heat resistance of the main body according to one embodiment. In this case, a coating on the lower side in particular affords the advantage that an adhesive connection, which is expediently formed there, also remains unchanged in the case of a thermal event.

Preferably, the coating comprises constituents or materials that are non-combustible and/or that have low flammability or is as such configured to have low flammability or be non-combustible.

According to a preferred embodiment, the coating comprises polyurea. The use of polyurea as coating material or as material constituent in the coating material can increase the temperature stability of the main body up to 1000° C. and more. It should be noted at this point that the expression “temperature stability” or “heat resistance” should in particular also be understood as meaning that the main body has low flammability or is not flammable. In particular, self-extinguishing advantageously occurs in the case of the action of temperature. The material of the main body may by all means be impaired in the process. By way of example, it may char or melt in certain regions. However, the essential structure as such advantageously remains due to the coating and/or due to the addition of the additives.

The additive or the additives are preferably materials that are non-combustible and/or that have low flammability.

According to one embodiment, the additive comprises at least one of the following materials: ammonium polyphosphate, PPM triazine, melamine cyanurate or melamine polyphosphate. According to one embodiment, the main body may also comprise a plurality of the aforementioned materials as additives. The aforementioned materials are distinguished in particular by a flame-retardant effect. The addition of such materials as additive to the main body has the effect that the shape of the main body also remains unchanged in the case of a thermal event.

According to one embodiment, the main body comprises ventilation openings which extend away from the arrangement surface. According to one embodiment, the ventilation openings extend perpendicularly or substantially perpendicularly with respect to the aforementioned plane. As an alternative or in addition, at least one or a plurality of ventilation openings may also be formed in an oblique or inclined manner with respect to the plane. In particular, the ventilation openings enable a flow path or air path which is directed away from the energy storage cells arranged on the main body. According to one embodiment, the ventilation openings extend into the arrangement surface. This means that the arrangement surface has corresponding holes or apertures, etc.

A main body comprising the aforementioned ventilation openings may also be referred to as honeycomb-shaped.

As already mentioned, the arrangement surface is of closed form according to a preferred embodiment. Correspondingly, the ventilation openings only begin below the arrangement surface. The honeycomb shape as such remains unchanged. According to one embodiment, the arrangement surface or the arrangement region is formed by a for example 2-5 mm thick layer of the main body in the region of the upper side. In the case of a thermal event in an energy storage cell, such a thin layer of the main body is pierced on account of the rapid and high pressure increase. This procedure advantageously already provides a throttle function which advantageously leads to a pressure reduction.

The main body is expediently formed in such a way that an exchange of gas is also made possible in a transverse direction. It is thus possible to effectively realize a pressure reduction. To this end, according to one embodiment, connecting channels which connect the ventilation openings in a fluid-conducting manner are provided in the region of the lower side of the main body. According to one embodiment, the connecting channels are oriented parallel to the aforementioned plane of the main body, wherein they are expediently able to occupy different directions in the plane.

According to one embodiment, the ventilation openings, connecting channels or generally the apertures, openings, etc. which are shaped/formed in the main body also have the, in particular fireproof, coating.

The invention is also directed to an energy storage arrangement comprising an absorber structure according to the invention, a multiplicity of energy storage cells being arranged on the arrangement surface of said absorber structure. The arrangement/fastening is preferably effected in a materially bonded manner, in particular by means of adhesive bonding.

According to a preferred embodiment, the energy storage cells are prismatic cells or particularly preferably round cells. Preference is given to energy storage cells whose degassing valves are oriented toward the absorber structure. The round cells are expediently arranged on the absorber structure or the main body so as to be upright, wherein the highest possible packing density is advantageously obtained. A conditioning device, in particular a cooling device, is advantageously arranged between the energy storage cells, which according to one embodiment are arranged in a plurality of rows.

Preferred types of energy storage cells are for example lithium-ion cells. It should, however, be expressly mentioned that the type of cell is not limited to this embodiment. Energy storage cells may, for example, also mean supercapacitors.

According to a particularly preferred embodiment, the energy storage cells are round cells, which are upright and extend along a vertical direction, and which are arranged on the arrangement surface, in particular next to one another, and wherein the ventilation openings are each formed in the extension of the energy storage cells.

Expediently, a ventilation opening is thus arranged in each case below an energy storage cell. This does not rule out the arrangement surface or the arrangement region being of closed form according to one embodiment.

As a result of the energy storage cells being arranged next to one another, intermediate spaces are formed between the cells. According to a preferred embodiment, the main body is designed, in particular formed, in such a way that the intermediate spaces are covered. In other words, the material of the main body is provided in the extension of the intermediate spaces. This in particular also has the effect that the intermediate spaces are protected or covered. If the material of the main body were to burn or combust in this region in the case of a thermal event, particles could be flung into the intermediate spaces. A short circuit could occur. The increased heat resistance or temperature resistance of the present main body makes it possible to ensure that the essential structure or the shape of the main body remains unchanged. Said main body can thus perform its intended functions.

According to a preferred embodiment, the main body is formed in such a way that ventilation is provided in the transverse direction, in relation to the aforementioned vertical axis. To this end, as already indicated, a multiplicity of connecting channels are provided, which are for example designed to connect the ventilation openings in the transverse direction. According to one embodiment, the connecting channels traverse the main body parallel to its plane. In addition or as an alternative, the connecting channels are formed or arranged directly on a lower side of the main body. Such connecting channels formed on the lower side may, for example, be in the form of material recesses. They thus do not have to be closed channels within the main body.

The invention also relates to an energy store housing comprising an, in particular metallic, housing, an absorber structure according to the invention being fastened to the housing. According to a preferred embodiment, the housing has an upper part and a lower part, in other words an upper housing part and a lower housing part. According to a preferred embodiment, the absorber structure is fastened in or to the lower housing part, and according to a preferred embodiment, is fastened in particular in a materially bonded manner, for example by means of adhesive bonding. The adhesive connection may be of areal form, or may alternatively be formed in certain portions, such as in a strip-like and/or punctiform manner.

According to a preferred embodiment, the lower housing part is of trough-like form. The housing or the energy store housing is advantageously closed by the arrangement of the upper housing part.

Expediently, the energy storage cells are fastened to the main body in a materially bonded manner. In particular, they are fastened to the coating in a materially bonded manner, which is formed on the arrangement surface. Preferably, the energy storage cells are fastened to the arrangement surface, or in particular to the coating formed there which expediently forms the arrangement surface, by means of adhesive bonding.

If the foam body is formed from EPP, a coating or the spray coating is expediently (also) formed on the lower side. According to one embodiment, when using polyisocyanurate (PU), no coating is applied to the lower side. The main body is expediently fastened directly to the housing lower part by means of adhesive. According to one embodiment, when using polyisocyanurate, a coating on the lower side can be omitted, since the surface energy of polyisocyanurate is higher and thus entails better adhesive properties. The coating expediently also has the advantage that the suitability of the main body for adhesive bonding can be increased.

The use of polyisocyanurate as material for the foam body is particularly advantageous with regard to recyclability, since then both the material of the foam body and the material of the coating are based on polyurethane.

The invention is also directed to a method for producing an absorber structure for energy storage cells, comprising the step of increasing the heat resistance or the temperature resistance of an absorber structure, comprising a main body composed of plastic, by coating at least certain regions and/or introducing an additive into the material of the main body.

The advantages and features mentioned in connection with the absorber structure, the energy storage arrangement and the energy store housing apply analogously and correspondingly to the method, and vice versa as well as in combination.

The method advantageously makes it possible to create a structurally stable adhesive surface. The creation of a non-combustible coating enables the production of a main body which has self-extinguishing properties. In this case, an absorber structure, as proposed, can be produced with short cycle times. Adjacent cells can be effectively protected in the case of a thermal event, since the main structure as such remains unchanged even in the case of high and very high temperatures. A main body composed preferably of foam, which has a honeycomb structure, is distinguished in particular by its low weight and its good crash properties. By way of the addition of one or more additives or by way of the coating, it is possible to reliably satisfy the temperature resistance.

The at least one additive can advantageously already be introduced, during the production of the main body, into the plastic, for example already into the base material from which the main body is foamed.

Further advantages and features will emerge from the following description of embodiments of an absorber structure, of an energy storage arrangement and of an energy store housing with reference to the attached figures.

### BRIEF DESCRIPTION OF THE DRAWINGS

FIG. 1 is a schematic sectional view of an energy storage arrangement;

FIG. 2 shows the arrangement known substantially from FIG. 1, wherein an arrangement surface of the main body has a coating;

FIG. 3 shows one embodiment of an absorber structure as seen from below, together with a detail view; and

FIG. 4 is a schematic partial view of one embodiment of an energy store housing.

### DETAILED DESCRIPTION OF THE DRAWINGS

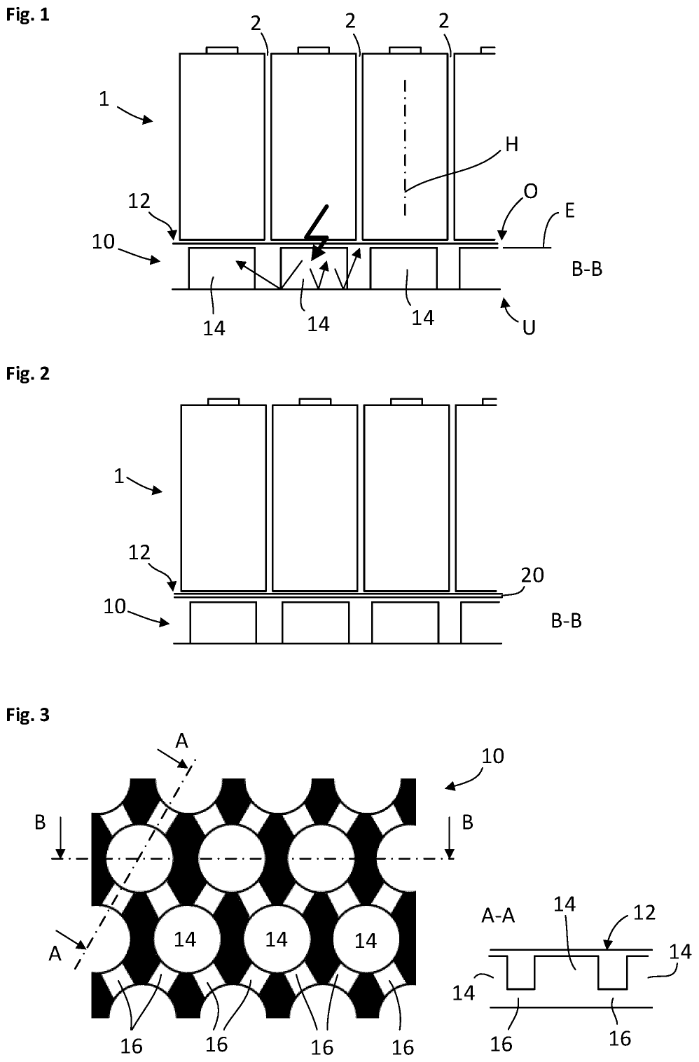

FIG. 1 schematically shows one embodiment of an energy storage arrangement in section, comprising an absorber structure which has a main body 10, wherein a multiplicity of energy storage cells 1, which in the present case are in particular in the form of round cells, are arranged on an upper side O of the main body 10. Intermediate spaces 2 are formed between the energy storage cells 1. The energy storage cells (or the round cells) 1 each extend along a vertical axis H, which in turn extends perpendicularly with respect to a plane E along which the main body 10 is oriented.

According to a preferred embodiment, the main body 10, as depicted in the present case, is in the form of a foam body. Reference designation 14 denotes a plurality of ventilation openings which are in the form of openings or apertures within the main body 10. In the present case, the ventilation openings 14 are formed in particular in the extension of the energy storage cells 1. Analogously, no ventilation openings 14 are formed in the extension of the intermediate spaces 2 between the energy storage cells 1. In other words, the material of the main body 10 lies here. In the present case, the absorber structure is of honeycomb-shaped form. As illustrated here, an absorber structure is arranged on or fastened to a lower housing part of an energy store housing for example by way of its lower side U, preferably in a materially bonded manner.

In the case of a thermal event in the second energy storage cell 1 from the left, a sudden temperature and pressure increase occurs below the cell 1, as schematically depicted by the jagged arrow. The degassing valve of the energy storage cells 1 is formed on their lower side, that is to say is oriented toward the absorber structure. In the case of such an explosion, substances/particles from the respective cell are flung downward in the direction of the housing lower part (not depicted here), where they for example ricochet and are flung back in the direction of the other energy storage cells 1. This is also depicted by way of corresponding arrows. If such particles pass into the intermediate spaces 2, a short circuit between the cells 1 may occur with correspondingly devastating consequences. Accordingly, it is important that the main body 10 as such remains unchanged even in the case of a thermal event.

FIG. 2 shows the arrangement known substantially from FIG. 1, wherein in the present case a coating 20, for example in the form of a spray application, is provided or arranged on an arrangement surface 12. The coating for example comprises polyurea or is formed from polyurea. It has been shown that polyurea applied by spraying can increase the temperature stability of the main body 10 up to 1000° C. and more. Charring of the main body 10 may occur, but not burning. As an alternative or in addition, the material of the main body 10 has one or more additives in order to increase the heat resistance and temperature resistance of same.

FIG. 3 shows one embodiment of a honeycomb-shaped main body 10 as seen from below. It is possible to see a multiplicity of ventilation openings 14 which extend through the main body 10, preferably in the direction of the energy storage cells. The ventilation openings 14 are preferably connected via a multiplicity of connecting channels 16. For reasons of clarity, not all of the ventilation openings and ventilation channels are provided with a reference designation. For better orientation, a section B-B is depicted in the present case. The section B-B is illustrated, as it were, in FIGS. 1 and 2. A section A-A is also depicted, which is emphasized in the right half of the image. It is possible to see how the ventilation openings 14 are connected via the connecting channels 16 on the lower side of the absorber structure or of the main body 10. It is also illustrated that, at least in the embodiment of the absorber structure or of the main body 10 depicted here, the arrangement surface or that region of the main body 10 which forms the arrangement surface 12 is in the form of a closed surface/plane. In the case of a thermal event, the arrangement surface 12 is pierced in the respective region as a result of the high pressure increase.

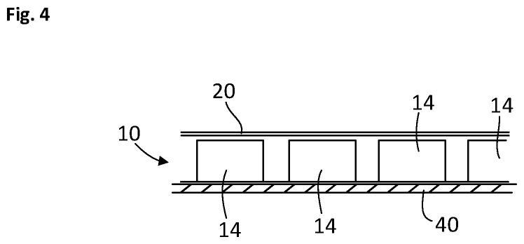

FIG. 4 shows a schematic view of a portion of one embodiment of an energy store housing, wherein a housing of the energy store housing, in particular a housing lower part, is depicted with the reference designation 40. The main body 10 of the absorber structure is expediently fastened thereto in a materially bonded manner, preferably by means of adhesive. The absorber structure or the main body 10 has a coating 20, preferably comprising polyurea, on its upper side. According to one embodiment, a coating 20 is also provided on the lower side, that is to say in the direction of the housing or housing lower part 40. According to one embodiment, the material of the main body is EPP. As an alternative, it is polyisocyanurate. When using polyisocyanurate, it is expediently possible to omit a coating 20 on the lower side, inter alia since the surface energy of polyisocyanurate is higher and thus entails better adhesive properties.

### LIST OF REFERENCE DESIGNATIONS

1 Energy storage cell, round cell
2 Intermediate space, gap
10 Main body
12 Arrangement surface
14 Ventilation opening
16 Connecting channel
20 Coating
40 Housing
O Upper side
U Lower side
H Vertical direction
E Plane

1.-14. (canceled)

15. An absorber structure for high-voltage stores, comprising:
a main body composed of a plastic;
wherein the main body comprises an arrangement surface for arrangement of a multiplicity of energy storage cells, and
wherein the plastic has an additive and/or the main body has a fireproof coating at least in certain regions, said additive and/or coating increasing heat resistance of the main body.

16. The absorber structure according to claim 15, wherein
the plastic is a foam, and
the foam is EPP or polyisocyanurate.

17. The absorber structure according to claim 15, wherein
at least the arrangement surface has the coating.

18. The absorber structure according to claim 15, wherein the coating is a sprayed-on coating.

19. The absorber structure according to claim 15, wherein the coating comprises polyurea.

20. The absorber structure according to claim 15, wherein
the additive comprises at least one of the following materials: ammonium polyphosphate, PPM triazine, melamine cyanurate, or melamine polyphosphate.

21. The absorber structure according to claim 15, wherein
the main body comprises ventilation openings which extend away from the arrangement surface.

22. The absorber structure according to claim 15, wherein the arrangement surface is in a form of a closed surface.

23. An energy storage arrangement, comprising:
a multiplicity of energy storage cells;
an absorber structure, for high-voltage stores, having a main body composed of a plastic,
wherein the main body comprises an arrangement surface for arrangement of the multiplicity of energy storage cells,
wherein the plastic has an additive and/or the main body has a fireproof coating at least in certain regions, said additive and/or coating increasing heat resistance of the main body, and
wherein the multiplicity of energy storage cells are arranged on the arrangement surface.

24. The energy storage arrangement according to claim 23, wherein
the energy storage cells are round cells which are arranged on the arrangement surface so as to be upright and to extend along a vertical direction,
the main body comprises ventilation openings which extend away from the arrangement surface, and
the ventilation openings are each formed in an extension of the energy storage cells.

25. The energy storage arrangement according to claim 23, wherein
intermediate spaces are formed between the energy storage cells, and
the main body covers the intermediate spaces.

26. The energy storage arrangement according to claim 23, wherein
the main body is formed such that ventilation is provided in a transverse direction.

27. An energy store housing, comprising:
a housing; and
an energy store arrangement according to claim 23, wherein
the absorber structure of the energy store arrangement is fastened to the housing.

28. A method for producing an absorber structure for high-voltage stores, the method comprising:
increasing a heat resistance of an absorber structure for high-voltage stores, the absorber structure comprising a main body composed of a plastic, wherein
the heat resistance is increased by coating at least certain regions of the main body and/or introducing an additive into a material of the main body.
